(19) United States
(12) Patent Application Publication
(10) Pub. No.: US 2004/0000794 A1
(43) Pub. Date: Jan. 1, 2004

(54) Laborsaving latch

(76) Inventor: Feng-Heh Wang, Hsinchu (TW)

Correspondence Address: RABIN & BERDO, P.C., 1101 14 Street, N.W., Suite 500, Washington, DC, 20005, US

(21) Appl. No.: 10/183,484

(22) Filed: Jun. 28, 2002

(51) Int. Cl. E05C 1/06

(52) U.S. Cl. 292/143

(57) ABSTRACT

A laborsaving latch is provided, which includes a handle, a latch bar and a wave-shaped spring. With the laborsaving latch being mounted on a door, the wave-shaped spring is fixed to the door, the handle is rotatably connected to the door, and the latch bar is pivotally connected to the handle. As the handle is operated to rotate, a portion of the handle coupled to the wave-shaped spring would be shifted in position with respect to the wave-shaped spring so as to drive the latch bar to move.

### FIELD OF THE INVENTION

The present invention relates to latches, and more particularly, to a laborsaving latch for use with a transportation container.

### BACKGROUND OF THE INVENTION

Generally, a latch mechanism is provided for locking a transportation container, such as a small-scale container (e.g. AKE model) used in an airplane, wherein A represents container category to be inspected or not, K represents base dimension of the container, and E represents contour dimension of the container. Such a latch mechanism usually utilizes a L-shaped iron rod as a latch. FIGS. 1A and 1B illustrate a conventional latch used in a transportation container. As shown in FIGS. 1A and 1B, a container door 11 is formed with a recess 111, and two bearings 132, 133 disposed in the recess 111 are used to accommodate a L-shaped latch 13 having a vertically-extending handle 131. A hole 121 is formed on a post 12 of the container door 11 corresponding in position to the latch 13. In operation, a user operates the handle 131 to insert the latch 13 into the hole 121 of the post 12; with engagement of the latch 13 with the post 12, the container door 11 can be locked.

In the use of the above conventional latch 13 illustrated in FIGS. 1A and 1B, resistance against movement of the latch 13 is mainly produced by frictional force between the latch 13 and the bearings 132, 133. In the case of cargoes (not shown) in the container being dislocated to press on the container door 11 during transportation, unlocking operation for decoupling the latch 13 from the hole 121 of the post 12 would become difficult to implement, and need great effort to overcome frictional force between the latch 13 and the bearings 132, 133. Moreover, if the post 12 is deformed by external impact, it also makes the latch 13 hardly withdrawn from the hole 121 of the post 12 in a manual manner. Furthermore, during transportation jolting, locking of the container door 11 by the latch 13 may be accidentally released, whereby the container door 11 is opened and cargoes in the container are dropped out. Therefore, if the latch 13 can be desirably fixed in position and firmly coupled to the container door 11, cargoes would be well secured in the container during transportation.

Taiwanese Patent No. 428651 discloses a conventional laborsaving latch for use with a transportation container. This laborsaving latch is constructed based on a lever principle for the laborsaving purpose. As shown in FIGS. 2A and 2B, a container door 21 is formed with a recess 211, wherein a first block 27 and a second block 28 are provided in the recess 211. A handle 24 is rotatably mounted in the recess 211 of the container door 21 via a shaft 243. A latch bar 23 has one end thereof being pivotally connected to the handle 24 via a pivot 232, and the other end of the latch bar 23 is inserted through a bearing 231 in a manner as to allow the latch bar 23 to be directed toward a hole 221 formed on a post 22 of the container door 21. A spring 26 is sleeved about the latch bar 23, wherein one end of the spring 26 is connected to the bearing 231, and the other end of the spring 26 abuts against a mount 25 fixed at a predetermined position in the recess 211 of the container door 21. As shown in FIG. 2A, when the container door 21 is not locked by the latch bar 23, the spring 26 is compressed with respect to the mount 25, and generates a resilient force for pushing the bearing 231 and the latch bar 23 toward the post 22; this resilient force associatively drives the handle 24 to clockwise rotate until a protruding head 241 at one end of the handle 24 comes into contact with the first block 27, which prevents further rotation of the handle 24 and temporarily holds the handle 24 in place.

For locking the container door 21 with the latch bar 23, a user operates a screw 242 to completely retract the protruding head 241 into the handle 24, so as to allow the handle 24 to keep moving without being blocked by the first block 27. Under effect of the resilient force generated from the spring 26 to push the latch bar 23, the handle 24 can keep rotating clockwise, until the bearing 231 on the latch bar 23 reaches periphery of the recess 211 of the container door 21 and the handle 24 comes into contact with the second block 28. As a result, the latch bar 23 can be inserted into the hole 221 of the post 22 for locking the container door 21, as shown in FIG. 2B. Such a latch mechanism is desirably laborsaving in operation through the use of the lever principle, and also allows the latch bar 23 to be firmly engaged with the container door 21 for securing cargoes in the container.

However, the above conventional laborsaving latch is complexly fabricated with many components or parts. And, it may be inherent with potential danger to hurt a user's hands that directly operate the complexly structured latch. Therefore, in response to these drawbacks, the problem to be solved herein is to provide a laborsaving latch that is simple in structure and safely operated by hands.

### SUMMARY OF THE INVENTION

A primary objective of the present invention is to provide a laborsaving latch that is simple in structure and safely operated in a manual manner.

In accordance with the above and other objectives, the present invention proposes a laborsaving latch, comprising: a handle, a latch bar and a wave-shaped spring. For a door being provided with the laborsaving latch, the wave-shaped spring is fixed to the door, the handle is fixed to the door and movably coupled to the wave-shaped spring, and the latch bar is pivotally connected to the handle. By rotating the handle, a portion of the handle coupled to the wave-shaped spring can be positioned at various trough portions of the wave-shaped spring, so as to drive the latch bar to operate to lock or unlock the door.

The wave-shaped spring can be constructed with a plurality of wave crests and wave troughs. Waveform of the wave-shaped spring can be of an arc shape, a V shape or an irregular shape.

In another embodiments the handle of the laborsaving latch is further provided with a pair of tab members that help positioning of the latch bar and set a limit of maximum moving distance for the latch bar.

In a further embodiment, the latch bar of the laborsaving latch, instead of the handle, is movably coupled to the wave-shaped spring. By rotating the handle, the latch bar can be positioned at various trough portions of the wave-shaped spring and adapted to operate to lock or unlock the door.

### BRIEF DESCRIPTION OF THE DRAWINGS

The present invention can be more fully understood by reading the following detailed description of the preferred embodiments, with reference made to the accompanying drawings, wherein:

FIG. 1A (PRIOR ART) is a front view of a conventional latch for use with a transportation container;

FIG. 1B (PRIOR ART) is a side view of the latch shown in FIG. 1A with a handle being rotated upwardly by 90 degrees;

FIG. 2A (PRIOR ART) is a front view of a conventional laborsaving latch in an unlocking condition;

FIG. 2B (PRIOR ART) is a front view of the laborsaving latch shown in FIG. 2A in a locking condition;

FIG. 3A is a front view of a laborsaving latch of a preferred embodiment according to the invention in an unlocking condition;

FIG. 3B is a front view of the laborsaving latch shown in FIG. 3A in a locking condition;

FIG. 4 is a perspective view of a wave-shaped spring used in the laborsaving latch according to the invention;

FIG. 5A is a front view of a laborsaving latch of another preferred embodiment according to the invention in an unlocking condition;

FIG. 5B is a front view of the laborsaving latch shown in FIG. 5A in a locking condition;

FIG. 6A is a front view of a laborsaving latch of a further preferred embodiment according to the invention in an unlocking condition; and

FIG. 6B is a front view of the laborsaving latch shown in FIG. 6A in a locking condition.

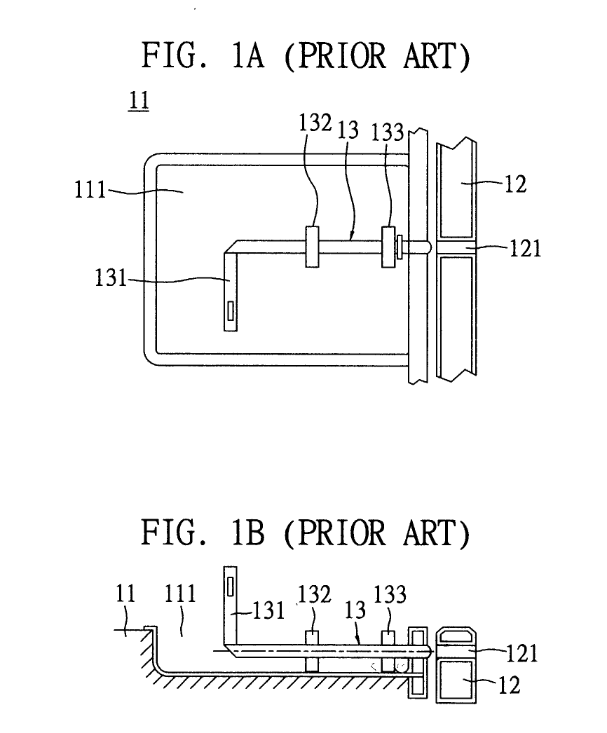

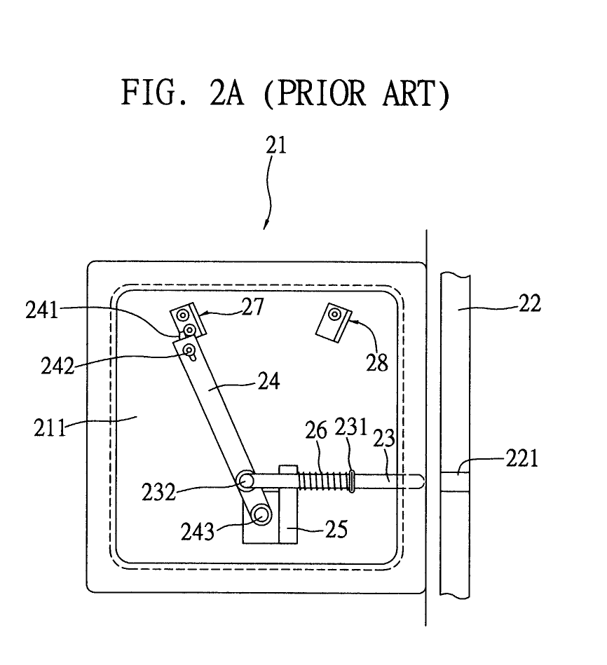

### DETAILED DESCRIPTION OF THE PREFERRED EMBODIMENT

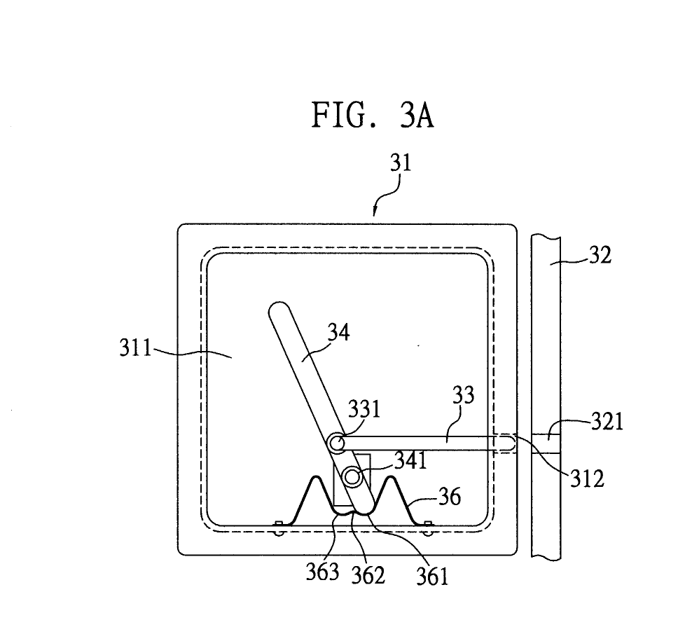

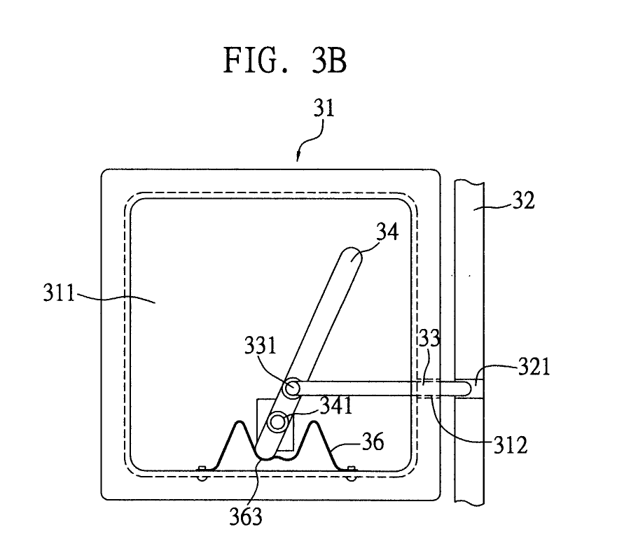

FIG. 3A illustrates a laborsaving latch of a preferred embodiment according to the invention in an unlocking condition. As shown in FIG. 3A, the laborsaving latch proposed in the invention is mounted in a recess 311 of a container door 31.

The laborsaving latch in this embodiment comprises a handle 34, a latch bar 33, and a wave-shaped spring 36. The wave-shaped spring 36 is disposed at a bottom side of the recess 311 of the container door 31. The handle 34 is pivotally fixed to the container door 31 via a shaft 341, and capable of rotating with respect to the shaft 341, wherein a bottom end of the handle 34 is movably coupled to a wave trough 361 of the wave-shaped spring 36. The latch bar 33 is pivotally connected at one end thereof to the handle 34 via a pivot 331, and the other end of the latch bar 33 passes through an aperture 312 provided on the container door 31 corresponding in position to a hole 321 formed on a post 32 of the container door 31.

For locking the container door 31 by the latch bar 33, a user operates the handle 34 to rotate clockwise with respect to the shaft 341, so as to allow the bottom end of the handle 34 to press over a wave crest 362 and overcome resilient resistance generated by the wave crest 362 to further reach another wave trough 363 of the wave-shaped spring 36. Meanwhile, the latch bar 33 is adapted to move toward the hole 321 of the post 32 and to be inserted into the hole 321 to lock the container door 31, as shown in FIG. 3B. At this stage with the container door 31 being locked, the bottom end of the handle 34 is positioned at the wave trough 363 of the wave-shaped spring 36. In the case of no external force or impact being exerted on the handle 34 to overcome resilient resistance generated by the wave-shaped spring 36, the latch bar 33 would be firmly held in place for securely locking the container door 31.

Likewise, for unlocking or opening the container door 31, the user only needs to drive the handle 34 in a reverse direction to rotate counterclockwise with respect to the shaft 341 in a manner that, the bottom end of the handle 34 is adapted to press over the wave crest 362 of the wave-shaped spring 36 and overcome resilient resistance generated by the wave crest 362, whereby the bottom end of the handle 34 can shift in position to the wave trough 361. Meanwhile, the latch bar 33 is moved leftwards out of the hole 321 of the post 32 to open the container door 31. In no concern of external force or impact being applied for rotating the handle 34, the latch bar 33 can be firmly held in place with the bottom end of the handle 34 being positioned at the wave trough 361, such that the container door 31 would be kept unlocked.

The handle 34 of the laborsaving latch, in accompany with the latch bar 33, forms a lever mechanism, wherein a position of the handle 34 held by hands acts as a force-applying point, a position of the handle 34 connected to the pivot 331 of the latch bar 33 acts as a force-receiving point, the shaft 341 acts as a fulcrum, and the bottom end of the handle 34 coupled to the wave-shaped spring 36 acts as a force-receiving point.

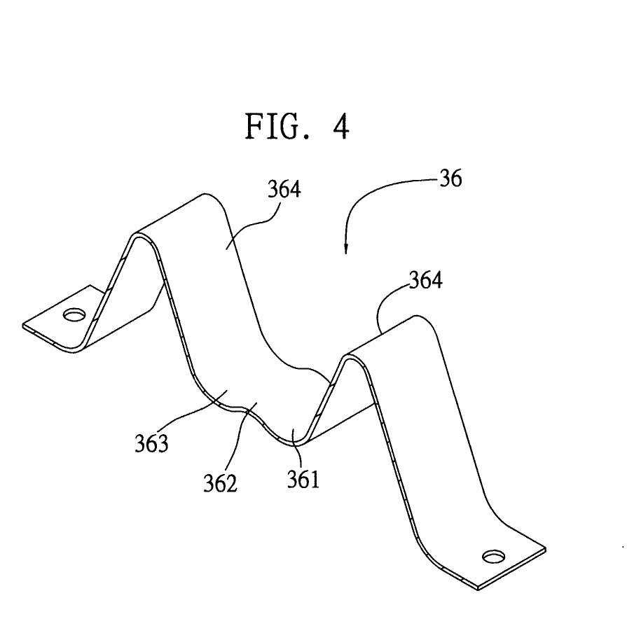

FIG. 4 illustrates a perspective view of a wave-shaped spring used in the laborsaving latch according to the invention. The wave-shaped spring 36 is of a M shape with two side walls 364, which are dimensioned in a manner as to allow the bottom end of the handle 34 to move within the side walls 364 without escaping out of the wave-shaped spring 36. Between the two side walls 364 there is formed a wavelike portion comprising two wave troughs 361, 363 and a wave crest 362 interposed between the two wave troughs 361, 363. The wave troughs 361, 363 are recessed with respect to the wave crest 362, so as to position the bottom end of the handle 34 within the wave troughs 361, 363 in response to different operations of the laborsaving latch. Therefore, by increasing the number of wave troughs and wave crests for the wave-shaped spring 36, the handle 34 can be adapted to be firmly held at more variable positions so as to provide more operational flexibility in the use of the laborsaving latch. The wave troughs and wave crests are preferably of an arc shape; nevertheless, other shapes such as V shape or irregular shape are also suitably adopted herein.

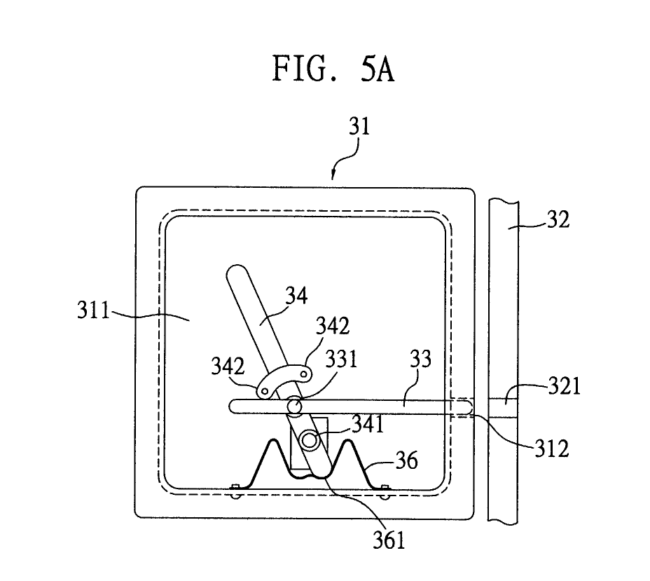

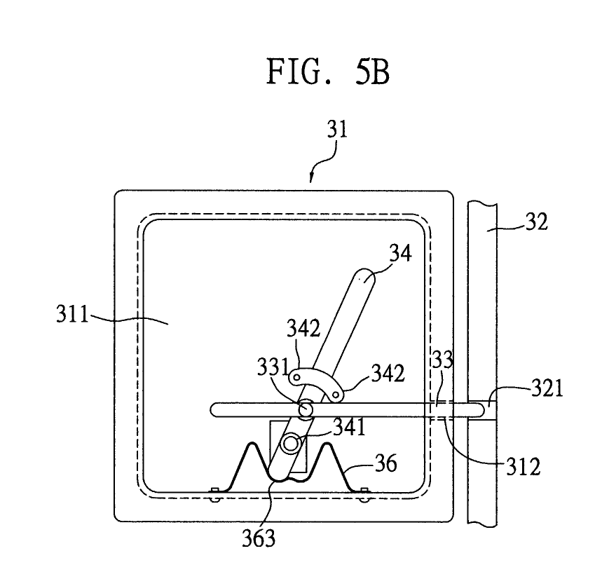

FIGS. 5A and 5B illustrate a laborsaving latch of another preferred embodiment according to the invention. This embodiment is similar in structure to the above embodiment shown in FIGS. 3A and 3B, except that in this embodiment, the handle 34 is additionally provided with a pair of tab members 342, and the latch bar 33 intercrosses with the handle 34 at the pivot 331. In operation of the laborsaving latch, when the bottom end of the handle 34 is located at one of the wave troughs 361, 363, a corresponding one of the tab members 342 abuts against the latch bar 33 that prevent further movement of the handle 34, so as to firmly hold the bottom end of the handle 34 in position within the wave trough 361, 363. Even with provision of more wave crests and wave troughs for the wave-shaped spring 36, the tab members 342 can thereby set a limit of maximum moving distance for the latch bar 33.

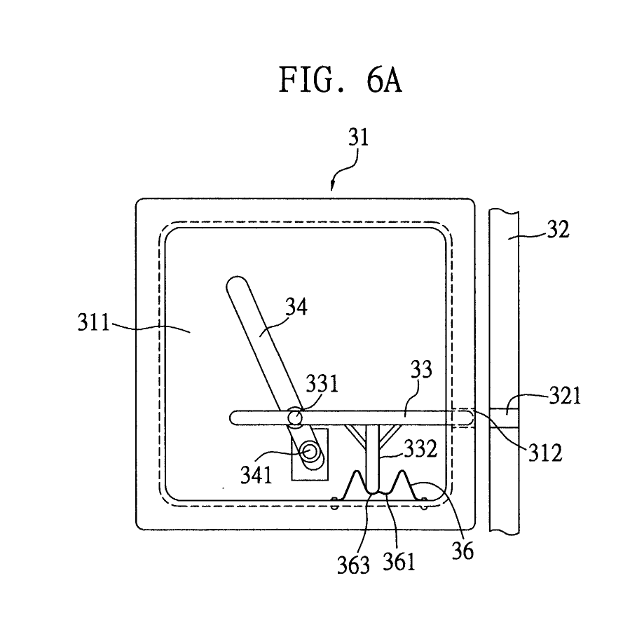

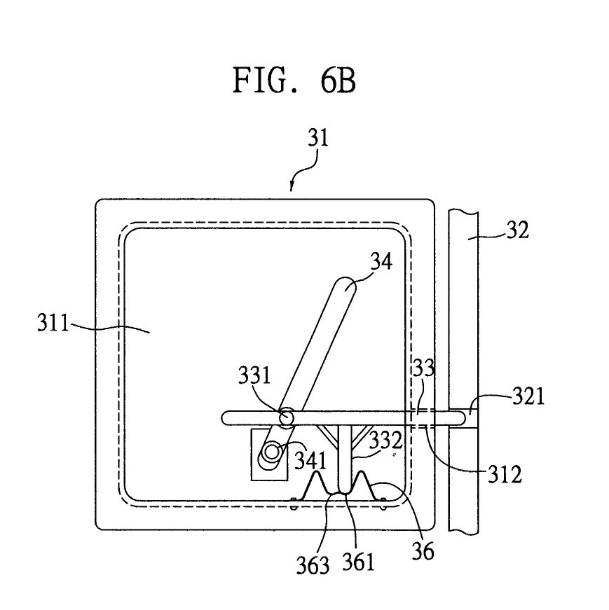

FIGS. 6A and 6B illustrate a laborsaving latch of a further preferred embodiment according to the invention. This embodiment is similar in structure to the above embodiment shown in FIGS. 3A and 3B, except that in this embodiment, the latch bar 33 intercrosses with the handle 34 at the pivot 331 and is provided with a leg member 332. A bottom end of the leg member 332, instead of the handle 34 of FIGS. 3A and 3B, is adapted to be positioned within the wave troughs 361, 363 of the wave-shaped spring 36.

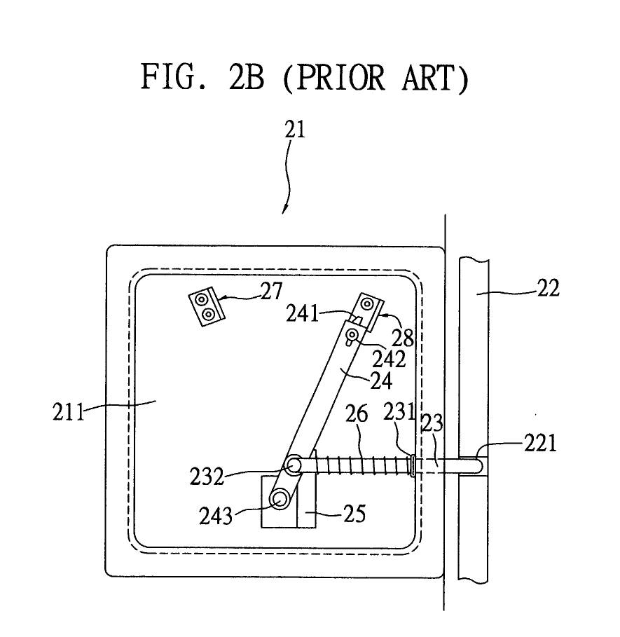

Besides the lever mechanism of the handle 34 and the latch bar 33, the laborsaving latch according to the invention also utilizes a single wave-shaped spring 36 for positioning and orientation-restoring purposes, in place of multiple components such as blocks 27, 28, spring 26 and mount 25 for a conventional laborsaving latch shown in FIGS. 2A and 2B; such a conventional complexly-structured latch may be inherent with potential danger to hurt a user's hands that directly operate the latch. Thereby, the laborsaving latch according to the invention is beneficial of being simple in structure and safely operated without causing harm to hands of a user.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A laborsaving latch for use in a door, comprising:
a wave-shaped resilient member fixed to the door;
a handle rotatably pivoted at the door and movably coupled to the wave-shaped resilient member; and
a latch bar pivotally connected to the handle and driven to move by rotation of the handle in a manner that, a portion of the handle coupled to the wave-shaped resilient member is adapted to be shifted in position with respect to the wave-shaped resilient member.

2. The laborsaving latch of claim 1, wherein the wave-shaped resilient member is a wavelike spring.

3. The laborsaving latch of claim 1, wherein the wave-shaped resilient member has two side walls and a wavelike portion interposed between the side walls, the wavelike portion at least comprising two wave troughs and a wave crest intervening between the wave troughs, allowing the portion of the handle coupled to the wave-shaped resilient member to move within the wavelike portion and to be positioned at one of the wave troughs in the use of the laborsaving latch.

4. The laborsaving latch of claim 3, wherein waveform of the wavelike portion is selected from an arc shape, a V shape and an irregular shape.

5. The laborsaving latch of claim 1, wherein a post of the door is formed with a hole corresponding in position to the latch bar, allowing the latch bar to move in a direction toward the hole of the post.

6. The laborsaving latch of claim 5, wherein the latch bar is inserted into the hole of the post for locking the door.

7. The laborsaving latch of claim 1, wherein the handle is provided with at least a tab member, and the tab member is adapted to abut against the latch bar during rotation of the handle, so as to allow the latch bar to move within a predetermined range of moving distance.

8. A laborsaving latch for use in a door, comprising:
a wave-shaped resilient member fixed to the door;
a handle rotatably pivoted at the door; and
a latch bar pivotally connected to the handle and movably coupled to the wave-shaped resilient member, wherein the latch bar is driven to move by rotation of the handle in a manner that, a portion of the latch bar coupled to the wave-shaped resilient member is adapted to be shifted in position with respect to the wave-shaped resilient member.

9. The laborsaving latch of claim 8, wherein the wave-shaped resilient member is a wavelike spring.

10. The laborsaving latch of claim 8, wherein the wave-shaped resilient member has two side walls and a wavelike portion interposed between the side walls, the wavelike portion at least comprising two wave troughs and a wave crest intervening between the wave troughs, allowing the portion of the latch bar coupled to the wave-shaped resilient member to move within the wavelike portion and to be positioned at one of the wave troughs in the use of the laborsaving latch.

11. The laborsaving latch of claim 10, wherein waveform of the wavelike portion is selected from an arc shape, a V shape and an irregular shape.

12. The laborsaving latch of claim 8, wherein a post of the door is formed with a hole corresponding in position to the latch bar, allowing the latch bar to move in a direction toward the hole of the post.

13. The laborsaving latch of claim 12, wherein the latch bar is inserted into the hole of the post for locking the door.

14. The laborsaving latch of claim 8, wherein the handle is provided with at least a tab member, and the tab member is adapted to abut against the latch bar during rotation of the handle, so as to allow the latch bar to move within a predetermined range of moving distance.
